(19) United States
(12) Patent Application Publication
(10) Pub. No.: US 2024/0074835 A1
(43) Pub. Date: Mar. 7, 2024

(54) IRRADIATION TECHNIQUES FOR ORTHODONTIC ALIGNERS

(71) Applicant: LightForce Orthodontics, Inc., Burlington, MA (US)

(72) Inventor: Celestino Nobrega, Burlington, MA (US)

(73) Assignee: LightForce Orthodontics, Inc., Burlington, MA (US)

(21) Appl. No.: 18/453,545

(22) Filed: Aug. 22, 2023

Related U.S. Application Data
(60) Provisional application No. 63/401,635, filed on Aug. 27, 2022.

(51) Int. Cl. A61C 7/08; A61C 7/00; A61C 13/00; B33Y 80/00

(52) U.S. Cl. CPC A61C 7/08; A61C 7/002; A61C 13/0006; B33Y 80/00

(57) ABSTRACT

Devices and methods for orthodontic treatments are disclosed. An orthodontic treatment may include patient-specific aligners formed of a polymeric material and configured to rearrange a patient's teeth according to a treating clinician's treatment plan. In some embodiments, a portion of the aligner may be irradiated or otherwise exposed to a specific light treatment, which may serve to change the stiffness of that portion of the aligner. In this way, the aligner may have a non-uniform stiffness profile, which may serve to apply different forces to different teeth when stationed in a patient's mouth. Modifying the magnitude of forces applied to the teeth and more precisely tuning the spatial distribution of the forces may expedite the orthodontic treatment.

### RELATED APPLICATIONS

This application claims priority under 35 U.S.C. § 119(e) to U.S. Provisional Application Ser. No. 63/401,635, titled “IRRADIATION TECHNIQUES FOR ORTHODONTIC ALIGNERS,” filed on Aug. 27, 2022, which is herein incorporated by reference in its entirety.

### FIELD

The disclosed embodiments relate generally to orthodontic appliances, more particularly to orthodontic aligners, including irradiated orthodontic aligners having varied and/or modified stiffness profiles.

### BACKGROUND

A misalignment of teeth, otherwise known as a malocclusion, can present medical challenges. Such medical challenges can include, for example, gum disease, tooth decay or loss, and long-term effects on the jaw. Malocclusions can also be aesthetically unpleasant and therefore undesirable for a patient. In some instances, a more aesthetic smile can enhance a patient's self-esteem and quality of life.

It is desirable for teeth to fit on a line of occlusion, which is a smooth curve through the central fossae and cingulum of the upper canines, and through the buccal cusp and incisal edges of the mandible. Any deviations from this line of occlusion can result in malocclusions. The field of orthodontics involves the study and management of malocclusions, as well as misaligned bite patterns (e.g., overbites) and jaw arrangements.

### SUMMARY

Some embodiments relate to a method of manufacturing patient-specific aligners, including obtaining an aligner, and irradiating at least a first portion of the aligner to achieve a stiffness of the at least a first portion of the aligner that is different from a stiffness of a different portion of the aligner.

According to some examples, the method includes accessing dentition data of a profile of teeth of a patient, and creating a three-dimensional computer-assisted design model of the patient's teeth based on the dentition data.

According to some examples, the method includes using an additive manufacturing technique to form the aligner using the three-dimensional computer-assisted design model.

Some embodiments relate to a method of manufacturing patient-specific aligners including irradiating at least a first portion of an aligner to achieve a stiffness of the at least a first portion of the aligner that is different from a stiffness of a different portion of the aligner while forming the aligner with a manufacturing technique.

According to some examples, the method includes accessing dentition data of a profile of teeth of a patient, and creating a three-dimensional computer-assisted design model of the patient's teeth based on the dentition data.

According to some examples, the method includes using the manufacturing technique to form the aligner using the three-dimensional computer-assisted design model, wherein the manufacturing technique is an additive manufacturing technique.

Some embodiments relate to a process for forming patient-specific aligners including obtaining an aligner, and irradiating at least a first portion of the aligner to achieve a stiffness of the at least a first portion of the aligner that is different from a stiffness of a different portion of the aligner.

According to some examples, the method includes accessing dentition data of a profile of teeth of a patient, and creating a three-dimensional computer-assisted design model of the patient's teeth based on the dentition data.

According to some examples, the method includes using an additive manufacturing technique to form the aligner using the three-dimensional computer-assisted design model.

Some embodiments relate to patient-specific aligners including a first irradiated portion, a second irradiated portion, and at least one un-irradiated portion, wherein a first stiffness of the first irradiated portion is different from a second stiffness of the un-irradiated portion, and wherein a third stiffness of the second irradiated portion is different from the second stiffness of the un-irradiated portion.

According to some examples, the patient-specific aligners are formed of a polyurethane material.

According to some examples, the patient-specific aligners are formed with an additive manufacturing technique.

According to some examples, the first stiffness of the first irradiated portion is different from the third stiffness of the second irradiated portion.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 schematically shows a dental chart, according to some examples;

FIG. 2 schematically shows an aligner having localized stiffness variations, according to some embodiments;

FIG. 3 shows a setup for irradiating aligners with UV illumination, according to some embodiments;

FIG. 4 shows exemplary spectral data from UV irradiated aligners;

FIGS. 5A-5B show a setup for irradiating aligners with blue light illumination, according to some embodiments;

FIG. 6 shows exemplary spectral data from blue light irradiated aligners;

FIG. 7 shows a comparison of exemplary spectral data from various irradiated aligners;

FIGS. 8A-8B show a setup for testing aligner stiffness, according to some embodiments;

FIGS. 9A-9B show exemplary results from aligner stiffness measurements; and

FIG. 10 shows a process of forming aligners with localized stiffness variations, according to some embodiments.

### DETAILED DESCRIPTION

Orthodontics has been widely adapted to correct malocclusions and straighten teeth. Conventional methods include using, for example, braces employing preformed brackets adhered onto a patient's teeth, with flexible metal archwires running through the bracket slots and providing sufficient static forces to induce bone remodeling and facilitate alignment.

Recently, given the advent of 3D scanning and improved additive manufacturing techniques, removable clear aligner trays (hereinafter referred to as “aligners”) have become more commonplace and are an affordable treatment option as an alternative to, or in conjunction with, conventional braces (e.g., as retainers). These removable aligners are formed based on digital scans of a patient's teeth (e.g., via intraoral scans), and adjusted based on the treatment plan. Aligners are highly customizable for each patient and aesthetically pleasing due to their transparency

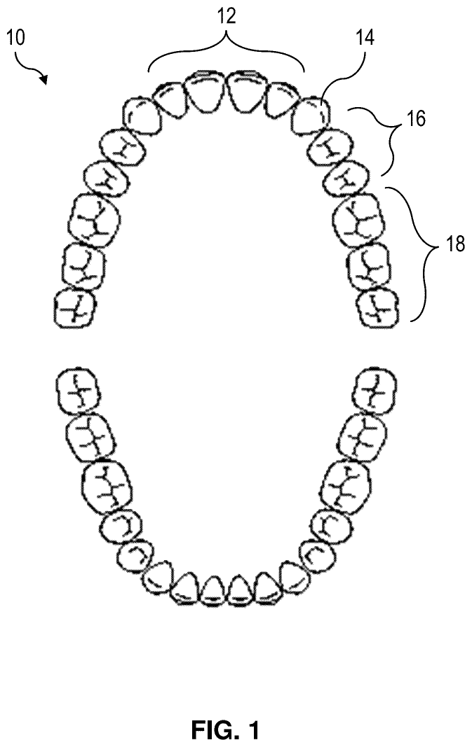

Conventional aligners are typically formed of a monolithic material with a uniform stiffness throughout the aligner. As a result, conventional aligners can only apply uniform forces to all the teeth on which they are stationed or worn. The Inventor has recognized that based on the various tissues in the mouth, different magnitudes of forces can be required to move teeth in different parts of the mouth. For example, as shown in the dental chart of FIG. 1, incisors 12 and canines 14 may require one amount of force (e.g., approximately 80 g of force) to move, premolars 16 may require a second amount of force (e.g., approximately 180 g of force), and molars 18 may require a third amount of force (e.g., between 280-320 g of force). Conventional bracket systems may be able to accommodate the various requirements of the teeth regimes by employing specific archwire materials and manipulating said materials to apply specific forces. The Inventor has recognized, however, that conventional aligners may apply unsuitable forces to some teeth (e.g., too much or too little force), which may prolong the orthodontic duration, increase costs for both the patient and the treating clinician, and/or create other problems for treatment. Accordingly, the Inventor has recognized a need for aligners capable of applying variable forces to different portions of a patient's teeth.

Based on the foregoing, the Inventor has recognized the benefits associated with a method of locally modifying the mechanical properties of an aligner to apply localized forces to the teeth on which they are stationed. The method may include, for example, locally stiffening and/or softening various portions of the aligner in order to apply a range of forces to the teeth. The Inventor has recognized that by locally tuning forces applied to a patient's teeth, the orthodontic treatment may be expedited, which may be desirable for both the patient and the treating clinician. However, instances in which different benefits are offered by the systems and methods disclosed herein are also possible.

In some embodiments, a method of locally modifying the stiffness profile of an aligner may include local irradiation with one or more light sources. The irradiation may include a first light source, which may serve to locally stiffen the aligner. The treated regions of the aligner may therefore apply a greater magnitude of force to the teeth relative to the untreated regions of the aligner. Such an arrangement may be desirable for certain teeth and/or in cases where a particular tooth is significantly out of alignment, such that a large magnitude of force may be needed to bring the tooth into alignment. Locally stiffening the aligner may apply a desirably large magnitude of force to the tooth without overworking other nearby teeth. In some embodiments, the irradiation may additionally or alternatively include a second light source, which may serve to locally soften the aligner. The treated regions of the aligner may therefore apply less force to the teeth, which may be desirable in certain orthodontic treatments.

In some embodiments, the first light source may emit wavelengths spanning blue light. As will be described in greater detail below, the Inventor has recognized that exposure to blue light at particular operational parameters may result in a stiffening of aligners. For example, exposing aligners formed of polyurethane to blue light can stiffen the aligners. Local and/or bulk exposure of blue light may therefore be employed to modify the stiffness of various portions of the aligner to achieve a desired stiffness profile. The variation of stiffness along the aligner may result in the aligner applying increased forces to specific portions of the teeth on which the aligner is stationed, which may more precisely manipulate the movement of the teeth, and, in some embodiments, expedite the orthodontic treatment. As will be described in greater detail below, in some non-limiting embodiments, the blue light may be emitted by an LED light source, but other types of light sources are also contemplated.

In some embodiments, the second light source may emit wavelengths spanning the UV spectrum, including UV-A and UV-B light. As will be described in greater detail below, the Inventor has recognized that exposure to UV light at particular operational parameters may result in a softening of aligners. For example, exposing aligners formed of polyurethane to UV light may soften the aligners. As noted above, exposure of UV light may therefore be employed to modify the stiffness of various portions of the aligner to achieve a desired stiffness profile, and subsequently apply precisely tuned forces to teeth on which the aligner may be stationed.

It should be appreciated that although two light sources are described herein, any suitable number of light sources may be used to achieve a desired stiffness profile along the aligners. In some embodiments, more than one light source may be employed to provide more than one stiffness along the aligner. In some embodiments, the same light source may be employed to provide more than one stiffness along the aligner, such as by modifying the operational parameters of the irradiation treatment protocol. Any suitable number of light sources (e.g., one and/or greater than one) may be employed to induce any number of locally different stiffness values along the aligner, as the present disclosure is not limited by the number of light sources used in the irradiation treatment nor the stiffness profiles. As noted previously, each aligner may be patient-specific and may include a stiffness profile specifically customized to the patient's treatment plan.

The term “light source” as used herein may refer to any system capable of delivering electromagnetic radiation to a sample (e.g., an aligner). The systems described herein may irradiate aligners at any suitable wavelengths or combinations of wavelengths of electromagnetic radiation. One or more light sources may irradiate aligners at wavelengths in the UV regime (e.g., between 200-400 nm), visible regime (e.g., between 400-780 nm), infrared regime (e.g., between 780-1500 nm), combinations thereof, and/or any other wavelengths of electromagnetic radiation. Light sources capable of irradiating aligners with light at wavelengths shorter than UV and/or longer than infrared are also contemplated. In some embodiments, one or more light sources may irradiate aligners at a single wavelength or a subset of wavelengths (e.g., a subset of visible light). For example, as described herein, in some embodiments blue light (e.g., between about 450-495 nm) can be used to irradiate the aligners, however the techniques are not so limited and other light can be used (e.g., red light between around 620 to 750 nm, etc.). It should be appreciated that the present disclosure is not limited by the type of light source (e.g., LED, laser, incandescent, among others) or range of irradiation wavelength(s).

The term “local” or “localized” as used herein may refer to any suitable portion of an aligner, including, but not limited to, a portion of a surface of the aligner (e.g., distal, buccal, lingual, mesial surfaces), a portion of the aligner corresponding to an entire tooth, a portion of the aligner corresponding to multiple teeth, combinations thereof, and/or any other portion of the aligner. In some embodiments, the irradiation processes described herein may be applied to the aligner in bulk. Accordingly, the present disclosure is not limited by the extent of the treated regions of the aligner.

It should be appreciated that the present disclosure is not limited by the material composition of the treated aligner. In some embodiments, an aligner formed of a polyurethane material may be employed. In other embodiments, the aligner may be formed of any suitable material including, but not limited to, polyurethanes, polyamides, polyesters (e.g., PETG), polycarbonates, polymethylmethacrylates, polypropylenes, polyester sulfones, acrylic materials, combinations thereof, and/or any other suitable material(s). In some embodiments, the aligner may be formed of a photosensitive polymer or photopolymer. The aligner may be formed of a material compatible with the manufacturing method (e.g., fused deposition modeling) used herein. It should be appreciated that the aligners described herein may be formed of any suitable biocompatible and hypoallergenic material, which may have high-heat resistance.

It should also be appreciated that although the aligners are described to be softened with UV light and stiffened with blue LED light, the present disclosure is not limited by the effect of irradiation on the aligners. For example, certain aligners may exhibit greater stiffnesses upon exposure to UV light. The relationship between the mechanical properties of the aligners and the irradiation treatment can depend on various numbers of factors, including, but not limited to, the material composition of the aligners and the treatment parameters (e.g., treatment wavelength, treatment duration, etc.), among others. Accordingly, the aligners of the present disclosure may be softened and/or stiffened by any clinically relevant magnitude (to facilitate orthodontic treatment) using any suitable irradiation method, as the present disclosure is not so limited.

The treatments described herein are also not limited by the fabrication technique by which the aligners are formed. Accordingly, the stiffening/softening treatments may be compatible with any suitable fabrication technique. The aligners may be formed using techniques spanning additive or substantive manufacturing, including, but not limited to, lithography-based manufacturing, inkjet printing, slip casting, laser lithography additive manufacturing, direct light processing, selective laser melting, vat photopolymerization (e.g., stereolithography), digital light processing, binder jetting, fused deposition modeling, powder bed fusion, electron beam melting, selective heat sintering, and selective laser sintering, sheet lamination, directed energy deposition, among others.

In some embodiments, the aligners may be thermoformed using a 3D printed patient-specific mold having the shape of the patient's teeth. The mold may be formed with a 3D CAD model of the patient's teeth, adjusted to address next steps in the orthodontic treatment. The mold may be formed using any suitable additive manufacturing technique. In an exemplary, non-limiting embodiment, a sheet of a thermoset material may be positioned over the mold and heated to a pliable temperature, while space between the mold and the thermoset material is vacuumed out. In this way, the sheet may be formed into an aligner by conforming to the mold. It should be appreciated that any other method of forming the aligners may be employed, as the present disclosure is not so limited.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

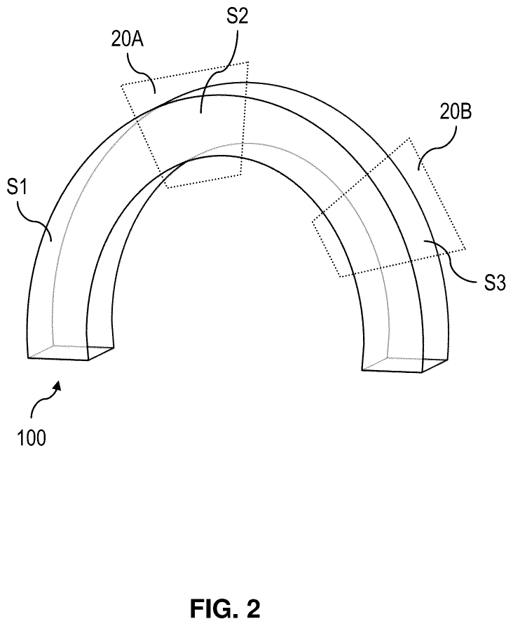

FIG. 2 shows, according to some embodiments, an aligner 100 having localized areas of stiffness 20A, 20B achieved by light irradiation compared to other portions of the aligner 100. The aligner may have a bulk stiffness S1, which may be less than, greater than, or equal to stiffnesses S2, S3 of the various areas of the aligner. Variations in aligner stiffness may achieve a desired orthodontic treatment by applying targeted levels of force onto specific teeth. In some embodiments, precise control of the force applied to each tooth may shorten the length of orthodontic treatment, which may be desirable for both the treating clinician and patient.

It should be appreciated that any number of areas (greater than or equal to one) may be irradiated to achieve a difference in the mechanical properties of the irradiated region, and that the areas 20A, 20B shown in FIG. 2 depict an exemplary and non-limiting embodiment.

In some embodiments, an aligner 100 may be locally treated with one or more treatments to achieve a desired non-uniform stiffness profile, designed to apply various magnitudes of force to targeted teeth. For example, a first area 20A of the aligner may be locally treated (e.g., irradiated with UV light) to achieve a stiffness S2 less than the bulk stiffness S1 of the aligner. The first area 20A may therefore apply less force to the teeth on which it may be stationed, relative to the portions of the aligner having a bulk stiffness S1. Similarly, a second area 20B of the aligner may be locally treated (e.g., irradiated with blue LED light) to achieve stiffness S3 greater than the bulk stiffness S1. The second area 20B may therefore apply more force to the teeth on which it may be stationed. In this way, the clinician may more precisely maneuver teeth to achieve a desired smile aesthetic.

In some embodiments, a bulk stiffness S1 of an aligner 100 may be different from its original stiffness. For example, the aligner 100 may be bulk treated with a first treatment (e.g., UV exposure) to achieve a different stiffness from its original stiffness. Various portions of the aligner may be masked to limit their exposure to the bulk treatment. For example, if the aligners are placed in a light box for UV treatment, various portions of the aligners may be coated with reflective or otherwise blocking material to limit the extent of UV exposure on said portions. In this way, various portions of the aligner may exhibit a different stiffness from the bulk, given the lack of exposure to the irradiation treatment. In some embodiments, the untreated or otherwise masked portions of the aligners may be further locally treated to achieve a desired stiffness profile along the retainer. Accordingly, the aligners described herein may be treated with any combination of localized and/or bulk irradiation treatments over any suitable portions of the aligner, as the present disclosure is not so limited.

It should be appreciated that any of the treatments described herein may be employed to uniformly treat an aligner. In some embodiments, an aligner may be exposed to bulk UV treatment to achieve relatively uniform stiffness throughout the aligner, without any localized differences in stiffness. In other embodiments, an aligner may be exposed to bulk blue LED treatment to achieve relatively uniform stiffness throughout the aligner. Accordingly, non-localized treatments of aligners are also contemplated, as the present disclosure is not limited by the localization of the irradiation treatment.

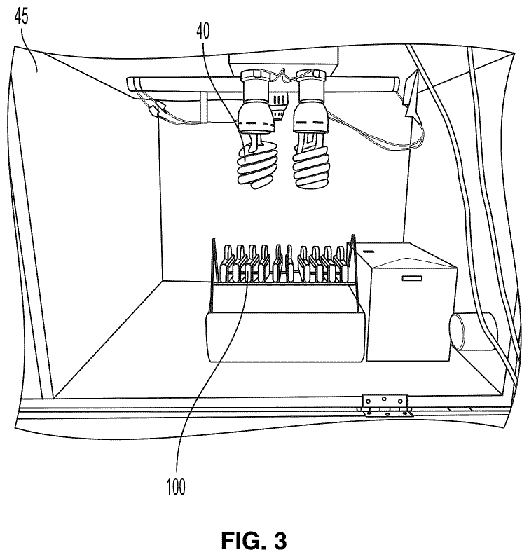

FIG. 3 shows, according to some embodiments, a setup for irradiating aligners 100 with UV light. The aligners 100 may be arranged in a lightbox 45, which may be lined with reflective material (e.g., foil) in order to uniformly expose the aligners to light emitted from lamps 40. In some embodiments, UV radiation may include exposure to light from both the UV-A and the UV-B regimes. For example, exposure can be to light between 300 and 400 nm, although other combinations of regimes of light are also contemplated. In a non-limiting exemplary embodiment, the lamps 40 include eight lamps in the UV-A regime, with each lamp operating at 8 W of power, and five lamps in the UV-B regime, with four lamps operating at 26 W of power and one lamp operating at 15 W of power. The lamps 40 may be arranged at a specific distance away from the aligners 100 to provide a desired uniform radiation distribution. FIG. 3 shows the lamps 40 arranged with a focal distance of 10 cm away from the aligners 100, but other arrangements are also contemplated as the present disclosure is not limited by the arrangement of the lamps relative to the aligners.

It should be appreciated that FIG. 3 represents a method of bulk treatment of aligners 100. Although not shown, portions of any of the aligners housed in the lightbox 45 may be masked to limit the exposure of said portions to the lamps 40. It should be appreciated that localized UV treatment, irradiating specific portions of the aligners rather than bulk irradiation, is also contemplated.

In some embodiments, aligners 100 may be exposed to treatment for a predetermined length of time(s) to achieve the desired change in stiffness. For example, the aligners shown in FIG. 3 may remain in the lightbox 45 for approximately 60 minutes to achieve a desired lowering of their bulk stiffness. It should be appreciated that the irradiation treatment duration may be any suitable period of one or more times. In some embodiments, the various parameters of irradiation treatment, including, but not limited to, number of lamps, duration of treatment, focal distance of the lamps, wavelength of irradiation, material composition of the aligners, arrangement of aligners in the lightbox, among others, may be adjusted to achieve a desired volume of light absorbance which may result in a desired change in stiffness. Accordingly, the aligners and/or treatment of the present disclosure are not limited by any of the aforementioned parameters, as they may each be tuned independently and/or in combination with one another to achieve a desired volume of light absorbance.

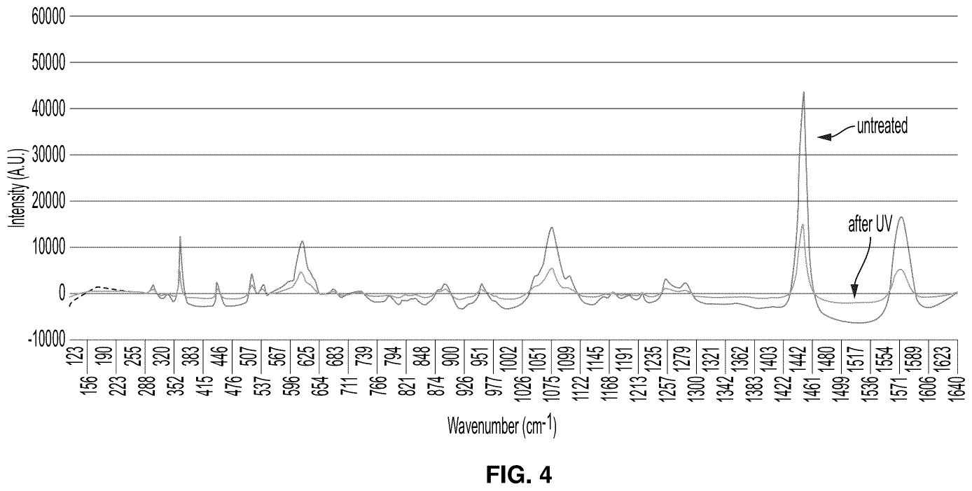

FIG. 4 shows an exemplary Raman spectrum collected from an untreated aligner and a spectrum collected from an aligner treated using the UV setup outlined in FIG. 3. The spectra may be collected from a small portion of the aligner corresponding to the incisor tooth, with Raman spectroscopy operating parameters including an 830 nm laser diode excitation operating at 250 mW of laser power, scanning 1200 lines/mm along a CCD of 1300 by 100 pixels, resulting in a resolution of 2 cm⁻¹. FIG. 4 shows variations in both peak amplitudes as well as peak positions along the spectrum. Without wishing to be bound by theory, changes in the Raman spectra may indicate changes in the vibrational state of the tested material (e.g., aligners), which may in turn indicate molecular structure changes. In some embodiments, the observable changes in the Raman spectra between the treated and untreated aligners may correspond with changes in mechanical properties (e.g., stiffness) of the aligners following irradiation treatment.

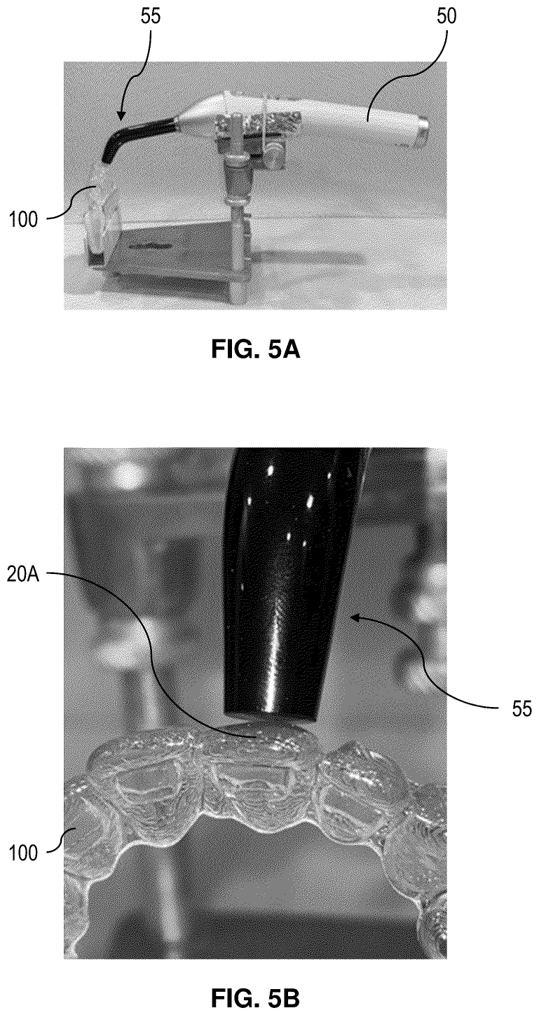

FIGS. 5A-5B depict, according to some embodiments, a setup for localized treatment of an aligner 100 using a light source 50. In some embodiments, the light source 50 may be an LED source operating in the regime of 440-480 nm. The light source may include a tip 55 (which may, in some embodiments, be a light guide rod) which can be positioned proximal to a desired area 20A of the aligner and subsequently irradiate area 20A. For example, FIG. 5B shows the tip 55 in contact with the surface buccal of the aligner 100 corresponding to the crown of the upper right central incisor. In some embodiments, the treated area 20A may correspond to a portion of a tooth, whereas in other embodiments, the treated area 20A may correspond to a whole tooth or more than one tooth. It should be appreciated that the present disclosure is not limited by the spatial extent of the irradiation treatment. The irradiation treatment duration of the area 20A may be any suitable duration, including, but not limited to 240 seconds. In some embodiments, the irradiation treatment may be cycled (e.g., six cycles of 40 seconds), such as to limit heat accumulation within the aligner. The light source may be configured to output any suitable areal power density, including, but not limited to 800-1000 W/cm².

As described in reference to FIG. 3, the various parameters of irradiation treatment, including, but not limited to, the areal power density, duration of treatment (and any suitable cycling), focal distance of the light source tip, wavelength of irradiation, material composition of the aligner, among others, may be adjusted to achieve a desired volume of light absorbance which may result in a desired change in stiffness. Accordingly, the aligners and/or treatment of the present disclosure are not limited by any of the aforementioned parameters, as they may each be tuned independently and/or in combination with one another to achieve a desired volume of light absorbance.

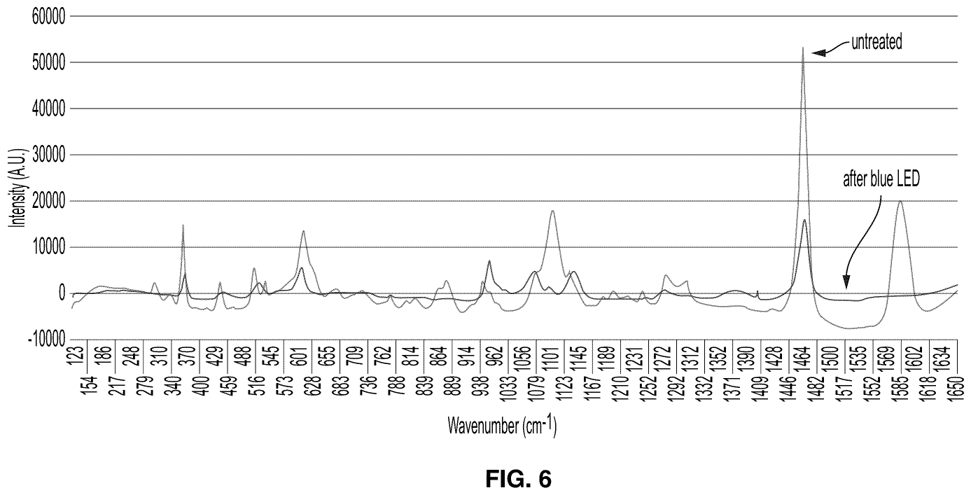

FIG. 6 shows an exemplary Raman spectrum collected from an untreated aligner and a spectrum collected from an aligner treated using the blue LED setup outlined in FIGS. 5A-5B. The spectra may be collected from a small portion of the aligner corresponding to the incisor tooth, using the Raman spectroscopy operation parameters outlined above. FIG. 6 shows variations in both peak amplitude as well as peak positions along the spectrum, which may suggest structural changes in the aligner composition, resulting in changes in mechanical properties.

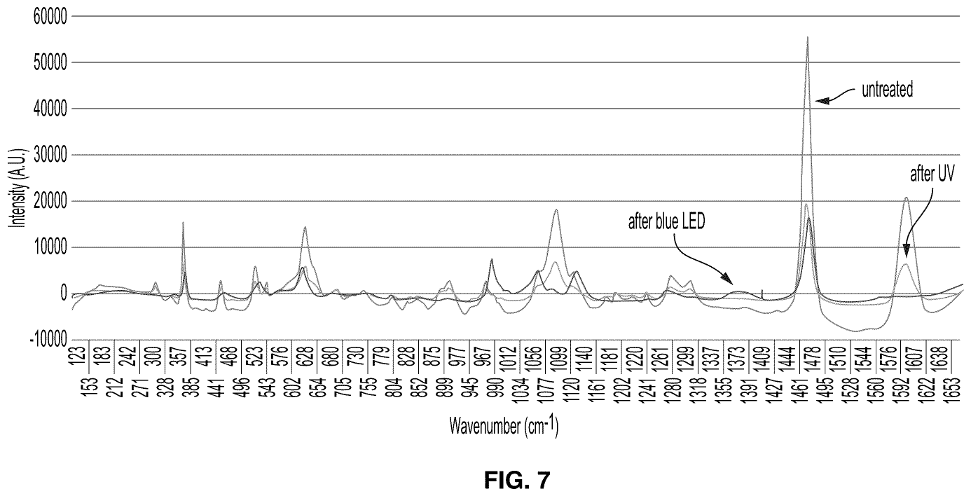

FIG. 7 shows a comparison of Raman spectra collected from an untreated aligner, one treated with UV light, and one treated with blue LED light. As shown, the three spectra exhibit observable differences in peak amplitudes along the spectra, as well as peak positions along the spectrum, which may suggest structural changes in the aligner composition, resulting in changes in mechanical properties.

As noted previously, the Inventor has recognized that a change in the Raman spectrum corresponding to the treated aligners may be indicative of a molecular structure change. In some cases, changes in molecular structure may correspond to changes in mechanical properties, such as stiffness. Accordingly, the stiffnesses of the treated aligners may be investigated to elucidate the relationship between irradiation and stiffnesses. As noted previously, changes in the stiffness of the aligner may allow a treating clinician to more precisely control the forces applied to a patient's teeth with the aligner.

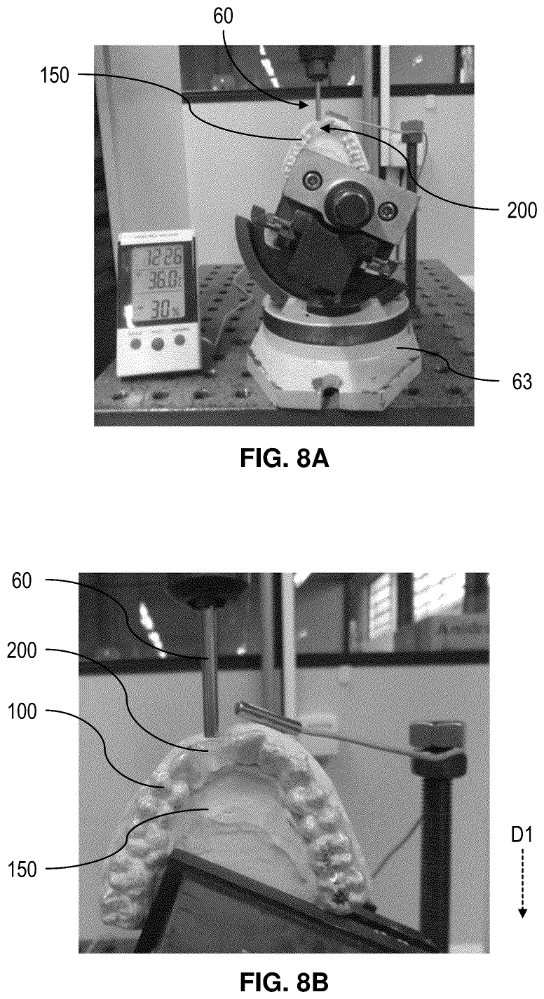

FIGS. 8A-8B depict an exemplary, non-limiting setup for measuring the stiffness of an irradiated aligner 100. Given the complex surfaces of the aligners described herein, in some embodiments, the stiffness of the aligners may be determined by testing a portion of the treated and/or untreated regime. For example, a portion of the aligner (e.g., corresponding to the upper right central incisor) may be selected to probe the stiffness of the aligners. As shown in FIGS. 8A-8B, the aligner may be filled with a stiff stone plaster mix (e.g., 100 g of plaster powder with 40 mL of water) with the exception of the selected portion. FIG. 8B shows a closeup of the filled aligner 100 showing the plaster filling 150, and the unfilled portion 200. The aligner may be arranged relative to a universal testing machine 60, which may apply a force (e.g., a downward force along direction D1, as shown in FIG. 8B) relative to the selected portion 200. The aligner may be fixed in place with a clamp stand 63, as shown in FIG. 8A.

Aligners may be mechanically tested using the following exemplary and non-limiting protocol shown in FIGS. 8A-8B. A cylindrical tip load cell (as part of the universal testing machine 60) may be arranged perpendicular to the most centralized region of the buccal surface of the referred tooth. The load may be limited to a maximum of 5 N, loading at a speed of 0.1 mm/min, with a contact surface (of the cylindrical tip) of 3.5 mm. The testing may be conducted under constant temperature of 36° C. and air humidity at 30%.

Data from deflection experiments conducted with the setup of FIGS. 8A-8B, spanning three sets of ten polyurethane aligners, may be examined with the Kruskal-Wallis test to determine statistical differences between untreated aligners, UV irradiated aligners, and blue LED irradiated aligners. Without wishing to be bound theory, the Kruskal-Wallis test (also known as the Kruskal-Wallis H test) is a non-parametric method for testing whether samples originate from the same distribution and indicates that at least one sample dominates the other in a random and non-deterministic way. Data medians of samples from the aforementioned three groups may be tabulated, with a null hypothesis that the medians of all groups are the same; and the alternative hypothesis is that at least the median of a group is different from the median of at least one other group. The tabulated results from deflection experiments spanning 10 untreated aligners, 10 UV irradiated aligners, and 10 blue LED irradiated aligners, are shown in Table 1 below, where K represents stiffness, calculated as the quotient of the load and the total deflection.

TABLE 1
exemplary results from deflection tests conducted for three groups of aligners

| | Control-untreated | | | UV treatment | | | Blue LED treatment | | |
|---|---|---|---|---|---|---|---|---|---|
| Sample | Load | Deflection | K | Load | Deflection | K | Load | Deflection | K |
| # | (N) | (mm) | (N/mm) | (N) | (mm) | (N/mm) | (N) | (mm) | (N/mm) |
| 1 | 5.009 | 0.28590 | 17.52 | 5.009 | 0.19470 | 25.73 | 5.003 | 0.163 | 30.6932 |
| 2 | 5.016 | 0.16990 | 29.52 | 5.006 | 0.21860 | 22.90 | 5.016 | 0.1769 | 28.355 |
| 3 | 5.009 | 0.24670 | 20.30 | 5.016 | 0.24750 | 20.27 | 5.006 | 0.1835 | 27.2806 |
| 4 | 5.019 | 0.20660 | 24.29 | 5.009 | 0.25270 | 19.82 | 5.006 | 0.1955 | 25.6061 |
| 5 | 5.022 | 0.13810 | 36.36 | 5.009 | 0.25400 | 19.72 | 5.025 | 0.15 | 33.5 |
| 6 | 5.009 | 0.16490 | 30.38 | 5.016 | 0.26810 | 18.71 | 5.019 | 0.1483 | 33.8435 |
| 7 | 5.006 | 0.26110 | 19.17 | 5.006 | 0.26590 | 18.83 | 5.016 | 0.1827 | 27.4548 |
| 8 | 5.019 | 0.17790 | 28.21 | 5.019 | 0.27580 | 18.20 | 5.022 | 0.1614 | 31.1152 |
| 9 | 5.019 | 0.20620 | 24.34 | 5.003 | 0.27060 | 18.49 | 5.016 | 0.1401 | 35.803 |
| 10 | 5.006 | 0.24370 | 20.54 | 5.013 | 0.25150 | 19.93 | 5.019 | 0.1662 | 30.1985 |

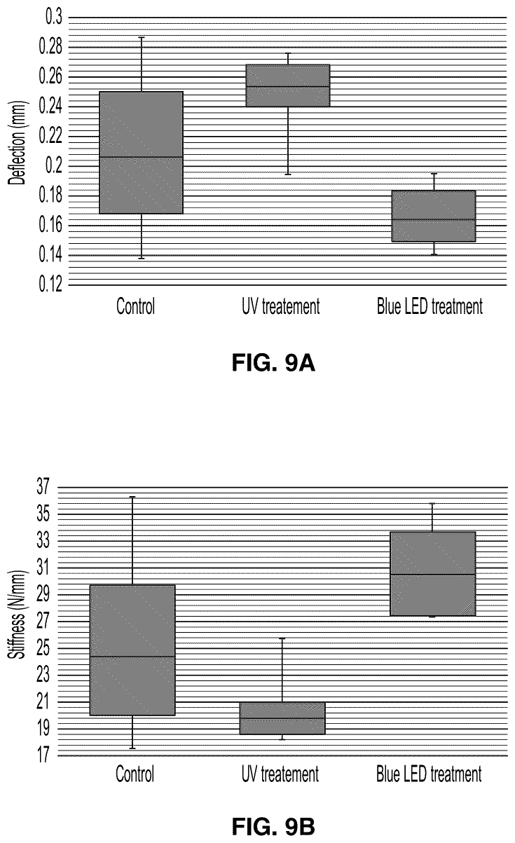

For improved visualization, FIGS. 9A-9B show boxplots of the data presented in Table 1 as a function of irradiation treatment or lack thereof. In order to determine the effect of irradiation on the aligners, various statistical analyses may be conducted to ensure the observed differences are statistically significant. First, a statistical comparison of the load applied to the three groups of aligners outlined in Table 1 may be conducted with the Kruskal-Wallis H test, with a significance level of 5%, resulting in a p-value of 0.371817. Accordingly, the null hypothesis is not rejected, showing that there may be no statistical difference in the load applied to the samples of the different groups.

Similarly, the Kruskal-Wallis H test may be applied to the measured deflection (tabulated as the maximum load deformation) and measured elastic constant outlined in Table 1, resulting in a p-value of 0.000475883 for the deflection and a p-value of 0.000475883 for the elastic constant. Thus, considering a significance level of 5%, the null hypothesis is rejected for both deflection and elastic constants of Table 1, suggesting that there is a significant difference between the three groups due to light (e.g., UV or blue LED) irradiation.

A Mann-Whitney test may also be employed to more closely assess the statistical significance between the groups, in a paired manner. Without wishing to be bound by theory, this test is indicated for comparing two unpaired groups to verify whether or not they belong to the same population. Various combinations of groups (e.g., untreated aligners with UV-treated aligners, UV-treated aligners with blue LED-treated aligners, and blue LED-treated aligners and untreated aligners) may be paired to evaluate the significant difference between them due to irradiation. With the null p-value in all cases, the null hypothesis is rejected for 5% significance. Therefore, it is likely that the statistical differences observed in Table 1 and FIGS. 9A-9B are a result of various irradiation treatments.

The elastic constant may similarly be analyzed to evaluate differences between different treatment groups. For these example cases, a p-value of 0.000976562 was obtained in all cases, allowing the null hypothesis to be rejected. Thus, considering a level of 5%, the test shows that irradiation treatment may be responsible for the statistically significant differences.

The data presented in Table 1 and analyzed in FIGS. 9A-9B exhibit an exemplary batch of aligners which suggest that UV exposure may increase, either locally or in bulk, the stiffness of polyurethane aligners, while blue LED exposure may decrease, either locally or in bulk, the stiffness of polyurethane aligners. As a result, various portions of an aligner may be treated with various irradiation treatments to form an aligner with varying localized stiffnesses to carry out a desirable orthodontic treatment. As noted previously, the experiments described herein are exemplary and non-limiting, such that any suitable irradiation treatment may be employed to modify the aligner stiffness, either locally or globally, as the present disclosure is not so limited.

It should be appreciated that the distribution of aligner stiffness may be customized for a specific patient's orthodontic treatment. A treating clinician may examine the patient's dental arrangement and plan a step-by-step treatment regarding how to move various teeth in particular directions and with particular forces in order to achieve an aesthetically pleasing smile (and/or to achieve other goals of the patient). The treatment may use one or a plurality of different aligners, including one or more aligners with localized stiffness variations, to carry out one or more of the treatment steps.

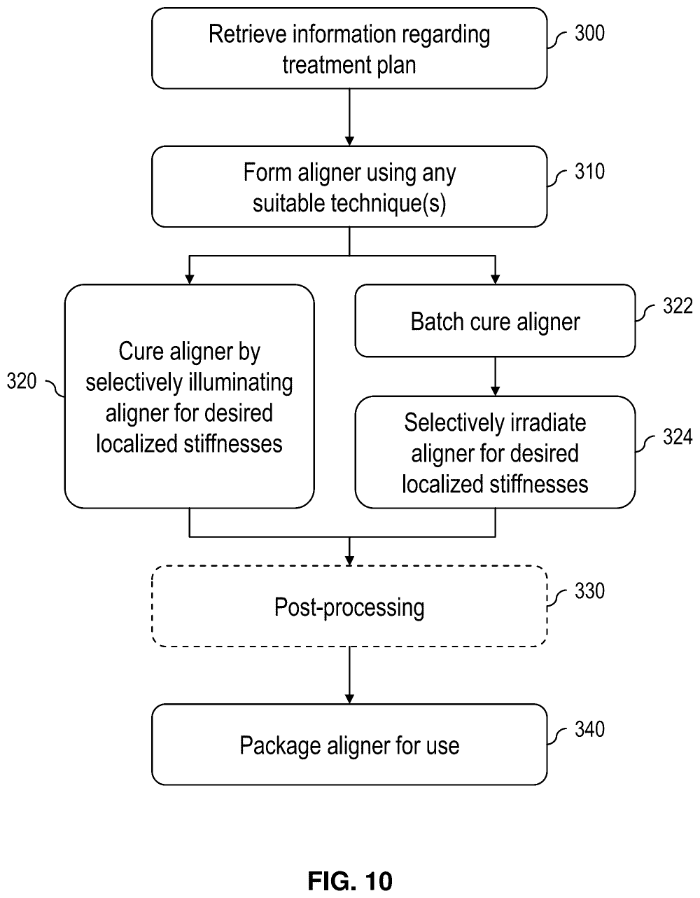

Accordingly, FIG. 10 depicts, according to some embodiments, a procedural flow chart for a method of fabricating a patient-specific aligner. The process may begin by retrieving the treating clinician's treatment plan, as shown in block 300. In some exemplary embodiments, the plan may include information regarding the current arrangement of the teeth, as well as the next sequential step of where the clinician intends to move the teeth. The current arrangement of the teeth may be determined using a measurement of dentition data of a profile of teeth of a patient. The dentition data may subsequently be used to form a three-dimensional computer-assisted design (3D CAD) model of the patient's teeth using reverse engineering. The model may then be adjusted to account for the treatment plan of the clinician, including information regarding which teeth may need force to move in a particular direction. The model may subsequently be fed into a system for manufacturing the aligner using any suitable technique(s), as shown in block 310. As described earlier, the technique may include fused deposition modeling, among other additive and/or subtractive methods. It should be appreciated that various information can be obtained at block 300 in addition to, or alternative to, the information described above. For example, the information may additionally or alternatively include specifications of the localized area(s), desired stiffness(es), and/or operational parameters as described herein. Such information can be provided by the treating clinician and/or by treatment planning software, for example.

Depending on the manufacturing method employed, in some embodiments, the aligner may undergo a simultaneous curing and treatment process, as shown in block 320, such that the aligner may be bulk cured while particular regions of the aligner may be treated to have desired levels of stiffnesses. For example, the treatment plan of block 300 may include data regarding which areas of the aligner may need to be exposed to UV light for reduced stiffness, and/or which areas of the aligner may need to be exposed to blue LED light for enhanced stiffness. Alternatively, in some embodiments, the bulk curing process, shown in block 322, and localized irradiation, shown in block 324, may occur sequentially. It should be appreciated that the methods of modifying the stiffness of aligners described herein are not limited by the order/sequence of events that include irradiation. In some embodiments, the localized irradiation of the aligner may occur at the treating clinician office, rather than during the manufacturing process. In other embodiments, the localized irradiation may take place during the 3D printing process of block 310. In some embodiments, the aligners may optionally undergo post-processing treatments, such as sterilization, as shown in block 330, prior to being prepared and packaged for use, as shown in block 340.

For purposes of this patent application and any patent issuing thereon, the indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

The use of “including,” “comprising,” “having,” “containing,” “involving,” and/or variations thereof herein, is meant to encompass the items listed thereafter and equivalents thereof as well as additional items.

It should also be understood that, unless clearly indicated to the contrary, in any methods claimed herein that include more than one step or act, the order of the steps or acts of the method is not necessarily limited to the order in which the steps or acts of the method are recited.

The foregoing description of various embodiments are intended merely to be illustrative thereof and that other embodiments, modifications, and equivalents are within the scope of the invention recited in the claims appended hereto.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter.

Various aspects are described in this disclosure, which include, but are not limited to, the following aspects:
1. A method of manufacturing a patient-specific aligner, the method comprising: obtaining an aligner, and irradiating at least a first portion of the aligner to achieve a stiffness of the at least a first portion of the aligner that is different from a stiffness of a different portion of the aligner.
2. The method of aspect 1, further comprising: accessing dentition data of a profile of teeth of a patient, and creating a three-dimensional computer-assisted design model of the patient's teeth based on the dentition data.
3. The method of any of aspects 1-2, further comprising using an additive manufacturing technique to form the aligner using the three-dimensional computer-assisted design model.
4. A method of manufacturing a patient-specific aligner, the method comprising: irradiating at least a first portion of an aligner to achieve a stiffness of the at least a first portion of the aligner that is different from a stiffness of a different portion of the aligner while forming the aligner with a manufacturing technique.
5. The method of aspect 4, further comprising: accessing dentition data of a profile of teeth of a patient, and creating a three-dimensional computer-assisted design model of the patient's teeth based on the dentition data.
6. The method of any of aspects 4-5, further comprising using the manufacturing technique to form the aligner using the three-dimensional computer-assisted design model, wherein the manufacturing technique is an additive manufacturing technique.
7. A patient-specific aligner formed by a process comprising the steps of: obtaining an aligner, and irradiating at least a first portion of the aligner to achieve a stiffness of the at least a first portion of the aligner that is different from a stiffness of a different portion of the aligner.
8. The aligner of aspect 7, further comprising: accessing dentition data of a profile of teeth of a patient, and creating a three-dimensional computer-assisted design model of the patient's teeth based on the dentition data.
9. The aligner of any of aspects 7-8, further comprising using an additive manufacturing technique to form the aligner using the three-dimensional computer-assisted design model.
10. A patient-specific aligner comprising: a first irradiated portion, a second irradiated portion, and at least one un-irradiated portion, wherein a first stiffness of the first irradiated portion is different from a second stiffness of the un-irradiated portion, and wherein a third stiffness of the second irradiated portion is different from the second stiffness of the un-irradiated portion.
11. The aligner of aspect 10, wherein the aligner is formed of a polyurethane material.
12. The aligner of any of aspects 10-11, wherein the aligner is formed with an additive manufacturing technique.
13. The aligner of any of aspects 10-12, wherein the first stiffness of the first irradiated portion is different from the third stiffness of the second irradiated portion.

What is claimed is:

1. A method of manufacturing a patient-specific aligner, the method comprising:
obtaining an aligner; and
irradiating at least a first portion of the aligner to achieve a stiffness of the at least a first portion of the aligner that is different from a stiffness of a different portion of the aligner.

2. The method of claim 1, further comprising:
accessing dentition data of a profile of teeth of a patient; and
creating a three-dimensional computer-assisted design model of the patient's teeth based on the dentition data.

3. The method of claim 2, further comprising using an additive manufacturing technique to form the aligner using the three-dimensional computer-assisted design model.

4. A method of manufacturing a patient-specific aligner, the method comprising:
irradiating at least a first portion of an aligner to achieve a stiffness of the at least a first portion of the aligner that is different from a stiffness of a different portion of the aligner while forming the aligner with a manufacturing technique.

5. The method of claim 4, further comprising:
accessing dentition data of a profile of teeth of a patient; and
creating a three-dimensional computer-assisted design model of the patient's teeth based on the dentition data.

6. The method of claim 5, further comprising using the manufacturing technique to form the aligner using the three-dimensional computer-assisted design model, wherein the manufacturing technique is an additive manufacturing technique.

7. A patient-specific aligner formed by a process comprising the steps of:
obtaining an aligner; and
irradiating at least a first portion of the aligner to achieve a stiffness of the at least a first portion of the aligner that is different from a stiffness of a different portion of the aligner.

8. The aligner of claim 7, further comprising:
accessing dentition data of a profile of teeth of a patient; and
creating a three-dimensional computer-assisted design model of the patient's teeth based on the dentition data.

9. The aligner of claim 8, further comprising using an additive manufacturing technique to form the aligner using the three-dimensional computer-assisted design model.

10. A patient-specific aligner comprising:
a first irradiated portion;
a second irradiated portion; and
at least one un-irradiated portion,
wherein a first stiffness of the first irradiated portion is different from a second stiffness of the un-irradiated portion, and wherein a third stiffness of the second irradiated portion is different from the second stiffness of the un-irradiated portion.

11. The aligner of claim 10, wherein the aligner is formed of a polyurethane material.

12. The aligner of claim 10, wherein the aligner is formed with an additive manufacturing technique.

13. The aligner of claim 10, wherein the first stiffness of the first irradiated portion is different from the third stiffness of the second irradiated portion.
